(19) United States
(12) Patent Application Publication
(10) Pub. No.: US 2025/0144531 A1
(43) Pub. Date: May 8, 2025

(54) Real-time Ray Traced Integrated Reality Gaming

(71) Applicant: Reuven Bakalash, Shdema (IL)

(72) Inventor: Reuven Bakalash, Shdema (IL)

(21) Appl. No.: 19/017,869

(22) Filed: Jan. 13, 2025

Related U.S. Application Data
(63) Continuation-in-part of application No. 18/420,062, filed on Jan. 23, 2024, now Pat. No. 12,220,643.
Application No. 18/420,062 is a continuation-in-part of application No. 18/222,698, filed on Jul. 17, 2023, now Pat. No. 12,151,166.
(60) Provisional application No. 63/396,246, filed on Aug. 9, 2022.

(51) Int. Cl. A63F 13/79; G06T 15/06

(52) U.S. Cl. CPC A63F 13/79; G06T 15/06; A63F 2300/8082

(57) ABSTRACT

The present disclosure integrates physical reality and virtual reality worlds, termed Integrated Reality, in a single gamified application. Both worlds share the same gaming environment, objectives, and context. The disclosure matches key advantages of a real-time ray tracing technology, taking the user's experience a quantum leap upward by a high degree of visual realism, bodily self-consciousness of the gamer, and camera angles with off-screen objects.

### CROSS-REFERENCE TO RELATED CASES

The present application is a Continuation in Part of U.S. application Ser. No. 18/420,062, filed Jan. 23, 2024, entitled “DESIGN and BUILD-INTEGRATED REALITY GAMING”, which is a Continuation in Part of U.S. application Ser. No. 18/222,698 filed Jul. 17, 2023, entitled “INTEGRATED REALITY GAMING” (now U.S. Pat. No. 12,151,166), which claims priority from U.S. Provisional Application No. 63/396,246 filed Aug. 9, 2022, entitled “Constructible combined reality games”, all of which are hereby incorporated by reference.

### FIELD OF THE DISCLOSURE

The present disclosure integrates physical reality and virtual reality in a single gamified application, matching the key advantages of real-time ray tracing technology, such as supporting bodily self-consciousness and camera angles with off-screen objects.

### BACKGROUND

Integrated-Reality. The postmillennial generation of kids, born in the Internet era, take the Internet and related digital networks and tools for granted; technology and online activities are incorporated into everything. As one of the young put it, “For me, online and offline are one and the same, basically the same thing, integrated” (R. Katz, S. Ogilvie, J. Saw, L. Woodhead; Gen Z, Explained. The Art of Living in a Digital Age. Chicago Univ. Press, 2021), which is fully incorporated hereby by reference. Postmillennial generations (Gen Z) are distinguishable from their elders, including the pre-Internet generation usually called millennials or Gen Y, precisely because they have never known life without the Internet. Computer gaming became a key component of the online activities of Gen Z. From 2000 to the present (the Online Boom) was the rise of the internet and mobile, which grew the computer gaming industry from tens of billions to hundreds of billions in revenue. The tidal wave of digital gaming has only continued to swell and become a key factor of the Integrated-Reality concept.

However, some of the pre-internet generations of legacy games, such as the plastic-bricks construction game of Lego®, remain an independent and necessary mainstay of full-reality gaming. Jorgen Vig Knudstorp, the Lego® CEO, has compared Lego® to books: “Just as children still want to read books, they still want to have the physical Lego® experience that cannot be replaced by digital play.”

Therefore, for the future generations, born into the dual world of physical and digital reality, there is a great need to bridge the pre-internet legacy games with digital gaming worlds, by way of Integrated-Reality (IR).

Virtual Reality. Virtual Reality, a prominent sub-category of digital reality, can be referred to as a technology that allows for replacing the real world with a synthetic one, making the user believe that she/he is in another realm. Traditional rendering techniques in virtual reality often struggle to achieve convincing lighting and shadow effects, leading to a somewhat flat and artificial-looking environment. On the other hand, the ray tracing technology traces the path of individual light rays as they interact with virtual objects creating stunningly realistic reflections, shadows, and global illumination effects. Ray tracing implementation in gaming and entertainment industries pushes the boundaries of visual fidelity, promising immersive experiences previously unimaginable. With real-time ray tracing virtual reality developers can accurately replicate the complex interplay of light, resulting in scenes that closely mimic real-world lighting conditions. Such an enhanced realism not only makes the virtual reality experiences more visually appealing but also enhances users' overall sense of immersion in the world of virtual reality, where users can experience and interact just as they would in real life.

Bodily self-consciousness. The experience of bodily self-consciousness or embodiment comes from the coherent multisensory integration taking place in the brain and relates to the notion of egocentric perspective on the self. In real life, we typically use mirrors and reflective surfaces for the egocentric first-person perspective. They play an important role in our psychological and emotional functioning. Reflections help us develop our sense of self. Researchers infer that if subjects can tell that the image on the reflective surface is in fact them, then they have developed a cognitive sense of self.

In fact, we come to develop a sense of self through early interactions in which our caregivers mirror or imitate our movements and emotional expressions and respond to us in ways that give us feedback that we are separate from them, and that our behaviour creates a reaction in them. It seems that we need a context outside ourselves to self-recognize—other people reflect us as individuals, and mirrors do too. We use the mirror as we do face-to-face communication: to get feedback on who we are and what we are experiencing at the moment. A quick glance in the mirror reaffirms our sense of self. If our facial image replaces the face of a movie character, then on top of his visual reflection one can identify with the hero.

To achieve a maximal experience of embodiment, the brain must be fed by images that are faithful to reality. Cinematographic movies are an important source of photorealistic images of self. However, to generate computer graphics images for virtual reality environment, such as of gaming applications, the 3D technology of ray tracing is imperative, since it is the only graphics technology capable of producing a very high degree of visual realism, and specifically reflectiveness and mirroring.

Ray Tracing. Ray tracing is a cutting-edge technology that has been used in the film industry for decades to create stunning visual effects. Compared to traditional rasterization techniques, ray tracing technology brings more lifelike visual effects to games, providing players with a more immersive gaming experience. Ray tracing-based rendering algorithms are fundamental in achieving photorealism in graphics by modeling the paths that rays of light take from a light source, to surfaces in a scene, and into the camera. It is a technique in which light transport algorithms simulate the way light-rays propagate through space (while interacting with objects), attaining the resulting colours for the screen pixels. It is capable of producing a very high degree of visual realism, higher than that of typical raster methods, but at a greater computational cost. Ray tracing is superior to raster graphics by its capability to simulate a wide variety of optical effects, such as glossiness, specularity, radiosity, reflection and refraction, scattering, soft shadows and more. Ray tracing is one of the most computationally complex applications. As such, it used to be suited for applications where the image can be rendered slowly ahead of time, such as in still images and film and television visual effects, and was poorly suited for real-time animated application of virtual reality where the real time animation is critical. Consequently, real time ray tracing is imperative for real time applications, such as gaming, virtual reality, augmented reality, etc.

At the Siggraph 2018 convention in Vancouver Nvidia introduced their Geforce RTX and Quadro RTX GPUs, based on the Turing architecture that allows for hardware-accelerated ray tracing. The Nvidia hardware uses a separate functional block, publicly called an “RT core”. The Geforce RTX became the first consumer-oriented brand of graphics card that can perform ray tracing in real time, and, in November 2018, Electronic Arts' Battlefield V became the first game to take advantage of its ray tracing capabilities.

However, there has been a high need to allow smartphones an access to the ray tracing technology as well. Is that become the future of mobile gaming as well? One of the primary reasons why hardware accelerated ray tracing might be not a good fit for mobile devices is the limited computing power of these devices. Whereas the Nvidia's Geforce RTX consumes above 200 W, which can be only supplied by desk top computers, high end laptops and gaming consoles; the battery driven mobile devices can supply only a low power of 1-3 W. There's also another huge problem: batteries. PCs, with exception of laptops, and consoles don't have those, so they don't need to worry about running out of power. Phones, on the other hand, run on very limited batteries so forcing it to use absolutely all of its resources to run a game will end up draining the battery in a matter of minutes. To add on to that, heat would also be a problem, as consuming battery fast and high usage of CPU will drastically increase the temperature of the device, that has very limited if any cooling capabilities. So, one can conclude that the hardware accelerated ray tracing is not the right technology for mobile devices.

However, to one's surprise, at the same Siggraph 2018 in Vancouver, a small startup company Adshir, founded and headed by Dr. Reuven Bakalash, were showing a ray-traced, 30 fps, full-screen real-time augmented reality graphics on a smartphone [Jon Peddie, Realtime ray tracing shown by Adshir at Siggraph, Graphic Speak, Aug. 9, 2019] [Jon Peddie, Real-time ray tracing on any smartphone available for years, it's finally available from Snap, JPR, Feb. 17, 2023]. But Adshir did it all in software, without special heavy-duty hardware. The new software ray tracing technology, LocalRay® was based on radical algorithmic improvements prioritizing regions that will receive the ray tracing light effects, and on a novel dynamic acceleration structure (DAS) with high locality, in which the changes in the scene are updated locally without effecting other locations. The DAS is constructed only once, and then only the required per-frame updates are done. A few years later, after acquiring Adshir, Snap Inc. was the first to bring real-time ray-tracing capabilities to mobile at scale, across Android and iOS. Nowadays, modern gaming on mobile devices relies on ray tracing to generate and enhance special effects. Although the application of ray tracing technology in current mobile games is still relatively limited, with the continuous development of technology, the popularity of ray tracing mobile games is an imminent and inevitable trend.

Gamification is a technology that incorporates elements of gameplay in nongame situations. It is used to engage customers, students, and users in the accomplishment of quotidian tasks. Gamification is using game design elements in non-game contexts, such as education, and others. The use of educational games as learning tools is a promising approach due to their ability to teach and reinforce knowledge and important skills such as problem-solving, collaboration, and communication. Games have remarkable motivational power; they utilize several mechanisms to encourage people to engage with them, often without any reward, just for the joy of playing and the possibility to win. As opposed to using elaborate games requiring a large amount of design and development efforts, the educational gamification approach suggests using game thinking and game design elements to improve learners' engagement and motivation.

In gamified applications, the player can be seen either as a first-person or a third-person. first-person is any graphical perspective rendered from the viewpoint of the player character. It is one of two perspectives used in the vast majority of video games, with the other being third-person, the graphical perspective from outside of any character (but possibly focused on a character).

Educational gamified applications are explicitly designed for educational purposes or have incidental or secondary educational value. Educational games are games that are designed to help transmit knowledge or foster skills and character traits.

Recent trends include the rise of virtual reality (VR) and augmented reality (AR), the incorporation of procedural generation techniques for dynamic content creation, and the integration of multiplayer and social interaction features. Very recently the ray tracing graphics technology became common for a more immersive VR and AR experience. These trends push the boundaries of gaming applications designer, creating new possibilities for immersive and engaging experiences.

### SUMMARY OF THE DISCLOSURE

Integrated Reality integrates the worlds of physical reality and digital reality in a single gamified application. Both worlds share the same gaming environment, objectives, and context. The present invention takes the user's experience a quantum leap upward by a high degree of visual realism and bodily self-consciousness of the gamer, both delivered by real-time ray tracing technology.

Players build a physical toy construction as a prototype for virtual reality, out of a set of standardized interlocking brick pieces. The is designed to match gaming environment, objectives, and context. The kit of toy construction contains a set of plastic standardized brick pieces. The construction effort generates an intimate familiarity with the constructed model and gaming world.

Utilizing real-time ray tracing technology, the physical toy prototype is reproduced into virtual reality environment of an enhanced, non-interlocking realistic look, as opposed to plastic-brick look of the physical model. The players can view the toy construction's exterior and interior faithfully to reality. A toy-sized structure, built by the player, transforms to world of virtual reality. The physical creation extends into imaginative and insightful experiences, blending the real and digital worlds.

The digital gaming is created at a higher-level design and game strategy matching the key advantage of ray tracing, such as bodily self-consciousness of the gamer. Ray tracing-based rendering algorithms are fundamental in achieving photorealism in graphics by modeling the paths that rays of light take from a light source, to surfaces in a scene, and into the camera. Real-time ray tracing is superior to raster graphics by its capability to simulate a wide variety of optical effects, among others reflection (mirroring). Using real-time mirroring, an exclusive feature of ray tracing, the generated images are capable to deliver a maximal experience of bodily self-consciousness, which may give us feedback on who we are and what we are experiencing at the moment. A quick glance in the mirror reaffirms our sense of self. If our facial image replaces the face of a movie character, then on top of his visual reflection one can identify with the hero.

Moreover, the real-time mirroring effect in a game allows exploring new and exciting camera angles. A story may be found inside a mirror or car reflection with off-screen objects or animations. They may hint what is happening in hidden parts of the scene (such as behind the gamer) to catch danger before time, wherein the gamer needs to make a tactical and strategic decision in a blink of time.

This is a new level of gaming taking the gamer's experience a quantum leap upward and upgrading the gaming rules. Certainly, a new level design and game strategy is required. The game designers need to raise the design level according to the new and unique information provided to the gamer, wherein the gamer needs to make new tactical and strategic decisions.

Development cycle for physical reality. A set of plastic bricks is designed for the physical toy construction of IR gamified application. Such physical reality construction may consist of toy building exteriors and their outdoor environment (trees, streets, lawn, etc.). A plastic brick kits may be either purchased off-the-shelf or developed as a custom architectural model, e.g. via Lego® MOC (stands for “My Own Creation”). The plastic-bricks kit should include all the parts needed, as well as printed instructions.

Development cycle of digital reality. Development breaks down into generic phase and customization phase. In the first phase a generic, site specific, virtual reality gamified application is developed. During the second phase the application undergoes customization to the playing person, implying environmental and storyline adaptations.

### BRIEF DESCRIPTION OF THE DRAWINGS

For a better understanding of the embodiments and to show how they may be carried into effect, reference will be made, purely by example, to the accompanying drawings.

With specific reference now to the drawings in detail, it is stressed that the particulars shown are by way of example and for purposes of illustrative discussion of selected embodiments only and are presented in the cause of providing what is believed to be the most useful and readily understood description of the principles and conceptual aspects. In this regard, no attempt is made to show structural details in more detail than is necessary for a fundamental understanding; the description taken with the drawings makes apparent to those skilled in the art how the several selected embodiments may be put into practice.

Embodiments are directed toward the integration of physical reality and virtual reality worlds in gaming. In this context, physical reality refers to a physical place where the player must be there to see it, and everyone presents sees essentially the same thing. In contrast, virtual reality refers to an environment created by computer software, where a player is remote from physical space but feels like he is in physical space. The player may also be able to see shared experiences with other players and/or see content unique to the individual.

Virtual reality (VR) is a simulated experience that employs pose tracking and 3D near-eye displays to give the user an immersive feel of a virtual world. standard virtual reality systems use either virtual reality headsets or multi-projected environments to generate some realistic images, sounds and other sensations that simulate a user's physical presence in a virtual environment. A person using virtual reality equipment is able to look around the artificial world, move around in it, and interact with virtual features or items. The effect is commonly created by VR headsets consisting of a head-mounted display with a small screen, or alternatively, the headset can be replaced by a tablet screen or by a mobile device screen.

As used in this specification, the singular indefinite articles “a”, “an”, and the definite article “the” should be considered to include or otherwise cover both single and plural referents unless the content clearly dictates otherwise. In other words, these articles are applicable to one or more referents. As this specification uses, “or” is generally employed to include or otherwise cover “and/or” unless the content dictates otherwise.

As used in this specification, the term “gamified application” may include the terms “educational gamified application” or “game”. The term “interior architecture” is the design of an interior for a given shell (exterior) of the building concerned. It refers to the design and plan used for a building's interior in architectural terms, to accommodate a gaming environment. The term “interior design” is the art of enhancing the interior of a building to achieve an appropriate environment for the gaming space, including conceptual development, space planning, and interior decoration.

In the accompanying drawings:

FIG. 1. illustrates the gaming stages of an Integrated Reality gamified application, played by a player in accordance with an exemplary embodiment of a present invention;

FIG. 2a. illustrates a schematic representation of a network-based gaming system of play and development, in accordance with an exemplary embodiment of a present invention;

FIG. 2b. illustrates a schematic representation of a physical and digital play units of an IR gaming system, detached from a server, in accordance with an exemplary embodiment of a present invention;

FIG. 3a. illustrates a schematic structure of the development platform for Integrated Reality gamified applications, in accordance with an exemplary embodiment of a present invention;

FIG. 3b. illustrates a schematic structure of the development platform for a digital stand-alone embodiment, in accordance with an exemplary embodiment of a present invention.

FIG. 4a. a hospital building structured of plastic bricks in the first example case, constituting a game environment, in accordance with an exemplary embodiment of a present invention (prior art);

FIG. 4b. illustrates a puzzle of a hospital building in the first example case, in accordance with an exemplary embodiment of a present invention (prior art);

FIG. 4c. illustrates a VR scene of a child-player with his caregiver both reflected in a mirror, in the first example case, in accordance with an exemplary embodiment of a present invention (prior art);

FIG. 4d. illustrates another VR scene of a child-player reflected in a mirror, in the first example case, in accordance with an exemplary embodiment of a present invention (prior art);

FIG. 5a. illustrates a mirrored character in a reflective car, viewed as a first-person shooter, in the second example case, in accordance with an exemplary embodiment of a present invention (prior art);

FIG. 5b. illustrates a mirrored character in a reflective car, viewed in a third-person game, in the second example case, in accordance with an exemplary embodiment of a present invention (prior art);

FIG. 5c. illustrates a first-person view of a mirrored character in a reflective car, in addition to two other reflections, in the second example case, in accordance with an exemplary embodiment of a present invention (prior art);

FIG. 6. Illustrates a block diagram of an exemplary system for implementing various aspects of the invention.

### DETAILED DESCRIPTION OF THE DISCLOSURE

Integrated Reality integrates the worlds of physical reality and digital reality in a single gamified application. Both worlds share the same gaming environment, objectives, and context. Applying Integrated Reality gaming enables a gamer to construct his own gaming environment in the physical world, and then extend his creation to an imaginative and insightful gaming experience, blending the real and fictive worlds.

Virtual reality (VR) comprises the digital reality component of integrated reality. VR can be referred to as a technology that allows for replacing the real world with a synthetic one, making the user believe that she/he is in another realm. Traditional rendering techniques in VR often struggle to achieve convincing lighting and shadow effects, leading to a somewhat flat and artificial-looking environment. Whereas ray tracing technology traces the path of individual light rays as they interact with virtual objects creating stunningly realistic reflections, shadows, and global illumination effects. Its implementation in gaming and entertainment industries pushes the boundaries of visual fidelity, promising immersive experiences previously unimaginable. With real-time ray tracing, VR developers can accurately replicate the complex interplay of light, resulting in scenes that mimic real-world lighting conditions. Such an enhanced realism not only makes VR experiences more visually appealing but also enhances users' overall sense of immersion in the world of virtual reality, where users can experience and interact just as they would in real life.

The present invention takes the virtual reality a quantum leap upward by high degree of visual realism and bodily self-consciousness of the gamer, delivered by a real-time ray tracing technology. Visual realism is necessary for achieving a maximal experience of embodiment, the brain must be fed by images that are faithful to reality. Bodily self-consciousness needs a mirror for a face-to-face communication: to get feedback on who we are and what we are experiencing at the moment. A quick glance in the mirror reaffirms our sense of self. If our facial image replaces the face of a movie character, then on top of his visual reflection one can identify with the hero.

Players build a physical toy construction as a model for virtual reality, out of set of standardized brick pieces that allow for the construction of a variety of different models. The physical constructing effort generates an intimate familiarity with the constructed model.

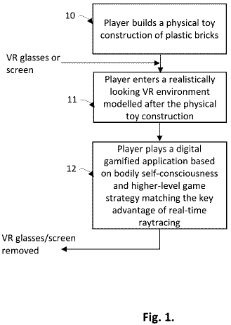

FIG. 1. illustrates the gaming stages of an Integrated Reality gamified application, played by a player in accordance with an exemplary embodiment of a present invention. Firstly, players build a physical toy construction (PTC) 10. According to some embodiments of the present invention the construction may be built out of a set of standardized brick pieces that allow for the construction of a variety of different models. The pieces avoid the lead time of requiring special training or design time to construct complex systems. This makes them suitable for temporary structures, or for use as children's toys. One very popular brand is LEGO®, however, other manufacturers are available as well, categorized according to pieces connection method and geometry. Alternatively, other building pieces maybe used as well, such as wooden cubes, etc.

By wearing VR glasses or using a tablet screen or a mobile device screen, the player finds the physical toy model transformed into a virtual reality environment 11. The virtual reality environment has an enhanced, realistic look, as opposed to plastic-brick look of the physical model. The toy structure, built by the player, becomes the place for virtual gaming activity, viewing the toy construction's exterior and interior faithful to reality. The player's physical creation extends into imaginative and insightful experience, integrating into the real and digital worlds.

The game has been created at a higher-level design and game strategy matching the key advantage of ray tracing 12. Ray tracing is superior to raster graphics by its capability to simulate a wide variety of optical effects. It implies that the generated images are not only faithful to reality, but they are also capable to deliver a maximal experience of bodily self-consciousness.

Therefore, players play a digital gamified application based on a high degree of realism and bodily self-consciousness within the virtual reality appearance of the physical toy construction. Use of mirroring in the game may give us feedback on who we are and what we are experiencing at the moment. A quick glance in the mirror reaffirms our sense of bodily self-consciousness and raise our involvement. If our facial image replaces the face of a movie character, then on top of his visual reflection one can identify with the hero.

More than that, a story may be found inside the mirror or car reflection with off screen objects or animations, allowing explore new and exciting camera angles. The reflections may provide new information to the player, such as an enemy behind the player or an enemy hiding behind the car, reflected at an incidental window. Reflections hint what is happening behind you or in hidden parts of the scene to catch danger before time.

This is a new level of gaming taking the gamer's experience a quantum leap upward, changing the gaming rules. Evidently, a new level design and game strategy is required for such a scene. The game designers need to raise the design level according to the new and unique information provided to the gamer, wherein the gamer needs to make a tactical and strategic decision in a blink of time.

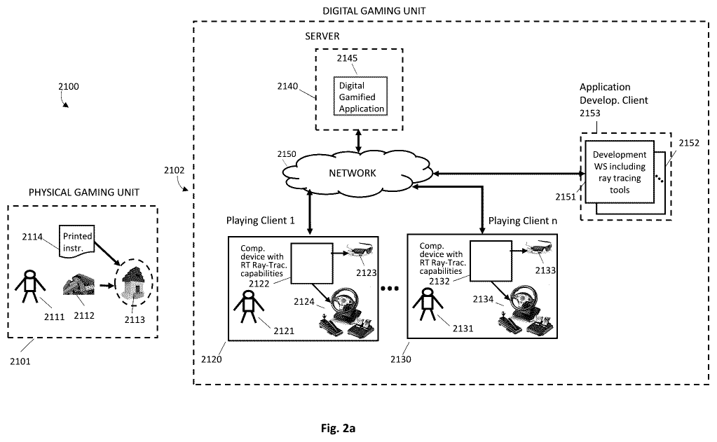

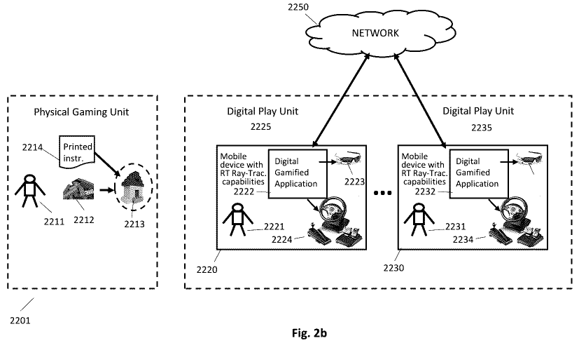

Reference now is made to FIG. 2a, which presents a schematic representation of Integrated Reality gamified application system, comprising its physical unit 2101 and digital unit 2102, in which the systems and methods of the present invention may be implemented and executed.

The physical gaming unit 2101 is concerned with building a toy size construction, of interlocking plastic bricks 2112 (or other building pieces, such as wooden bricks, wooden cubes, etc.). A complete set of such interlocking pieces can be supplied to the player for constructing a physical model, possibly assisted with assembling instructions 2114. The toy construction, 2113, may be of any kind: a hut, a spaceship, a multistore building, a neighborhood of industrial hangars or a mixed environment of buildings and trees, but all must match the storyline of the game. The physical world must share the same gaming environment, objectives, and context with the digital part of integrated reality.

The digital gaming system 2102 may be implemented by a client-server computing architecture. A computing server is a piece of computer hardware or software that provides functionality for other programs or devices, called “clients”. This architecture is called the client-server model. Servers can provide various functionalities, often called “services”, such as sharing data or resources among multiple clients or performing computations for a client. A single server can serve multiple clients. A client process may run on the same device or may connect over a network to a server. In the case of Build and Design Integrated-Reality gamified application of present invention the use of a server ensures the client that changes to the design occur rapidly. This category of software as a service puts an emphasis on usability and speed.

Clients and server communicate over a computer network 2150. Typically, they are on separate computers, however, in some embodiments both client and server may reside on the same computer, without the need of network. A network may consist of any network that enables communication between or among systems, machines, repositories, and devices (e.g., between the server 2140 and the clients 2151, 2120, 2130, etc.). Accordingly, a network may include one or more portions that constitute a private network, a public network (e.g., the Internet), or any suitable combination thereof. Network may include one or more portions that incorporate a local area network (LAN), a wide area network (WAN), the Internet, a mobile telephone network (e.g., a cellular network), a wired telephone network (e.g., a plain old telephone service (POTS) network), a wireless data network (e.g., a Wi-Fi network or WiMAX network), or any suitable combination thereof. Any one or more portions of network 2150 may communicate information via a transmission medium. As used herein, “transmission medium” refers to any intangible (e.g., transitory) medium that can communicate instructions for execution by a machine and includes digital or analogue communication signals or other intangible media to facilitate communication of such software.

The digital gaming system of present invention 2102, as illustrated in FIG. 2a, comprises a server 2140, application development client 2153, and playing clients 2120, 2130 (etc.). All are interconnected by network 2150. The application development client 2153 consists of one or more workstations 2151, 2152 for developing the digital part of integrated reality gamified application 2145. The playing client devices 2120, 2130 comprise computing devices such as, but not limited to, personal or desktop computers, laptops, notebooks, handheld devices such as smartphones, tablets, gaming consoles and/or any other computing platform known to persons of ordinary skills in the art. Mobile device (smartphone) is a portable device that combines mobile telephone and computing functions into one unit. They are distinguished from feature phones by their stronger hardware capabilities and extensive mobile operating systems, which facilitate wider software, Internet (incl. WEB browsing over mobile broadband), and multimedia functionality (including music, video, cameras, AR, and gaming). However, a smartphone may be replaced or assisted by a tablet computer, a vehicle computer, or a wearable device. In any case the playing client computing device must have enough computing power to run a real-time ray tracing application.

The development workstation 2153 must be equipped with ray tracing development tools to work on the present invention's IR gamified application. When the gamified application is completed, it may be moved from the development client 2153 to the server 2145, for serving up the playing clients. The game is played on a digital play unit (e.g. 2225) while connected to the digital gamified application 2145 on the server 2140.

Reference now is made to FIG. 2b, which illustrates a schematic representation of a physical and digital play units of an IR gaming system, detached from a server, in accordance with an exemplary embodiment of a present invention. It differs from the representation of FIG. 2a, in that the playing units 2220 and 2230 are stand alone, interconnected to each other by network 2250, but not to server or WS.

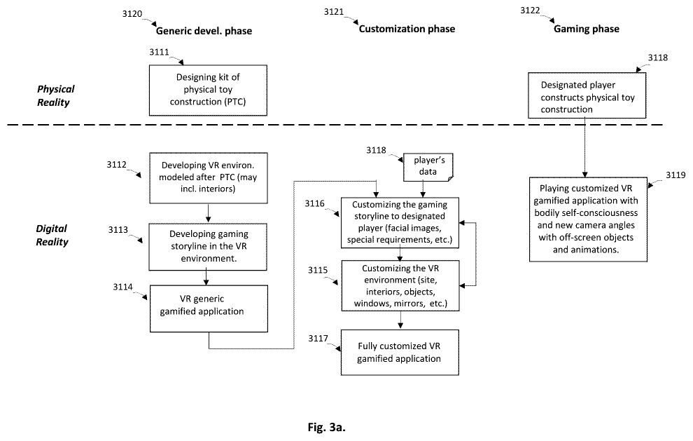

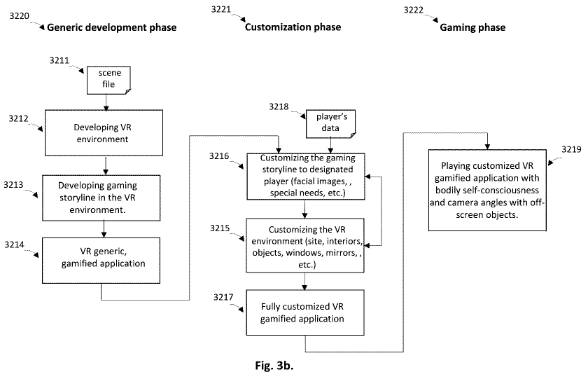

FIG. 3a illustrates a schematic structure of the development platform for Integrated Reality gamified applications, in accordance with an exemplary embodiment of the present invention. The development breaks down to generic development phase 3120 and customization phase 3121.

In the physical reality part 3111 of the generic phase, a set of plastic bricks for the physical toy construction is designed. Such physical reality construction consists of toy building exteriors and their outdoor environment (trees, streets, lawn, etc.).

In the digital reality part of the first phase a virtual reality site and gaming are designed and implemented. The virtual site is modeled after the physical toy construction 3112, implementing mainly buildings and their outdoors as the gaming world. Which indoors will be visited during the game will depend on further customized storyline. However, in some cases, it may include some specific interiors as well. Next, a generic, virtual reality gaming is developed 3113 based on the virtual site. The gaming may include storyline, pre-customized characters, user interface, etc. The generic VR gamified application, including gaming site and raw gamification, is finalized 3114, ready for customization. It is still generic, meaning that a customization to specific player must be done.

The second phase 3121 customizes the application. The gaming application must be adapted to designated player (or players), location and accordingly to conformed storyline. This will be closely clarified, hereinafter, by exemplary cases #1 and #2.

The customization starts with feeding the player's personal data 3118. Once the player is introduced to the application for customization, he becomes a designated player. The player's personal data includes at least his facial images, to support bodily self-consciousness. However it can include other personal information as well, such as special personal needs that effect the game. In the exemplary case #1, hereinafter, the gaming application must be adapted to designated child according to the required medical department in the hospital. The customization may consist of reproducing the building's interior, of planting “incidental” mirrors for the player's self facial image, etc.

Yet other personal data of a designated player can be used as well, e.g., children with hardships, anxiety, or diverse learning abilities may be helped to overcome the difficulty of regular video games by personalizing gamified application into enjoyable system. Moreover, a gamified environment can be tailored to the child's specific challenges, allowing children to receive positive digital reinforcement involving bodily self-embodiment, helping them overcome the barriers.

The customization is a mutually inducted process between customizing to designated player (e.g. personalization of the storyline, facial images, clothing, etc.) 3116, and customizing to specific VR environment (site, interiors, objects, placing mirroring objects in critical junctions of the gaming plot, etc.) 3115. Finally, the fully customized VR gamified application 3117 is ready to be played by designated player(s).

The physical reality step 3118 of the gaming phase 3122 is fully adapted to the player (or players). In the first step the player playfully constructs the physical toy construction which transforms to virtual reality environment, for playing a fully customized and unique virtual reality gamified application 3119, with bodily self-consciousness and new camera angles with off-screen objects and animations.

A stand-alone embodiment of the present invention is shown in FIG. 3b. A schematic structure of the development platform consists of digital reality components only. The development breaks down to two phases: generic development phase 3220 and customization phase 3221. In the first phase 3220 a virtual reality site and gaming are designed and implemented. The virtual scene definition of the gaming world is fed from scene file 3211. In this stand-alone embodiment the gaming world 3212 is not limited, it may consist of building exteriors and interiors, their outdoors, vehicles, spaceships, or any other objects. However, the gaming world is not necessarily complete yet, it may change in the customization phase.

A generic, virtual reality gaming is developed 3213 based on the virtual environment. The gaming may include storyline, pre-customized characters, user interface, etc. The gaming will be later updated when customized to designated player.

When the gaming world and raw gamification are finalized 3214, the intermediate product is still generic, potentially matchable to various designated players.

The second phase 3221 customizes the application. The gaming application must be adapted to designated player (or players), and the storyline and location must be accordingly updated. This will be closely demonstrated hereinafter by exemplary cases #1 and #2.

The customization is a mutually inducted process between customizing to designated player (e.g. facial images, personalization of the storyline, clothing, etc.) 3216, and customizing to specific VR gaming world, if required (site, interiors, objects, placing mirroring objects in critical junctions of the gaming plot, etc.) 3215. Finally, the fully customized VR gamified application 3217 is ready for playing.

The resulting gaming phase 3222 is fully adapted to the player (or players) to play fully customized and unique virtual reality gamified application, including bodily self-consciousness and new camera angles with off-screen objects and animations.

### Exemplary Case #1. Healthcare Gamified Application

The following exemplary case helps children, through gamified and enjoyable system, to overcome resistance and avoidance in hospitals and medical centers. Many children find it difficult to walk into a clinic or doctor's office for a checkup. By applying an integrated reality approach comprising a physical construction of the designated clinic model and its virtual reality indoor, the child can stay and interact in the clinic just as he would in real life.

An immersive virtual reality experience may be achieved by ray tracing technology, capable of generating high degree of visual realism, as well as real time virtual mirrors and reflective surfaces, contributing to child's egocentric perspective. A right utilization of the integrated worlds of physical reality and digital reality may reduce children fear and increase their cooperativeness with the practice of medical procedures and checkups through physical occupational therapy and digital simulation involving self-consciousness, respectively. This method may prepare the children, in a gamified and virtual way, for a checkup, surgery, or any other procedure at the medical center, thus dramatically reducing children resistance to cooperate with the treatments, saving time, manpower, and aggravation.

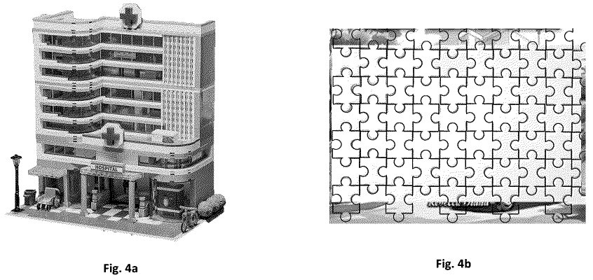

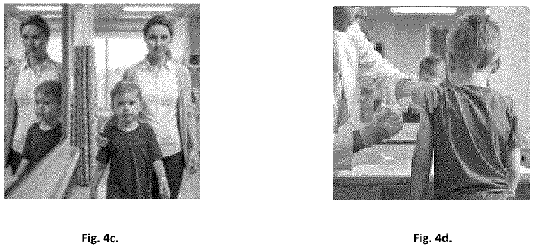

The physical reality phase comprises an effort of building a hospital's model with child's own hands. It is intended to lower the child's fear barrier, increase his cooperativeness and make him involved. For the older and capable children, the hospital physical model may be physically constructed out of 3D plastic bricks (FIG. 4a), while for the younger of less handy children the bricks maybe substituted by a puzzle (FIG. 4b), for assembling a 2D image of the hospital. A plastic brick kit of the hospital could be either purchased or developed as a custom architectural model, e.g. via Lego® MOC (stands for “My Own Creation”). The plastic-bricks kit should include all the parts needed, as well as printed instructions. The initiative for developing such a kit or alternatively a puzzle, may come from the hospital or from the child's caregivers.

The digital reality phase is based on a virtual reality with high degree of visual realism. To achieve a maximal experience of embodiment, the brain must be fed by images that are faithful to reality. The only 3D graphics technology capable of producing such a visual realism, specifically real time reflectiveness and mirroring, is ray tracing. Therefore, by applying real-time ray tracing, the hospital indoor scenes are reproduced, along with reflective and mirroring objects encountered on player's virtual path, arising self-consciousness of the child.

The child experiences the virtual visit using either VR glasses or a screen of a tablet or a mobile device. FIG. 4c shows a third person's view of the child and his mother walking in a hospital passageway. Both are reflected in a nearby mirror contributing to the child's egocentric perspective on the self. The virtual medical procedure is shown in FIG. 4d, while the virtual character cooperates with the nurse. The playing (real) child identifies himself in the mirror. So, in a virtual way, the child practices the medical situation safely, before undergoing it in real life. There are good chances that later, in real life, he will cooperate and perform that situation successfully.

The development cycle of the gamified application of case #1, is divided into two phases, as shown in FIG. 3, the developing phase and customization phase.

Firstly, the physical toy construction of the hospital building is designed, built out of plastic bricks. Such a physical reality construction consists of the building exterior and its outdoor environment. In the digital part of the first phase a generic, site specific VR gamified application is developed. Firstly, a VR environment modeled after PTC is developed 3112, mainly the building and its outdoor. However, it may include some interiors shared by all departments, such as the hospital lobby. The gaming is designed in 3113, including storyline, pre-customized characters, user interface, etc. The generic, site specific VR gamified application is finalized 3114, ready for customization.

The second phase of customization consists mainly of reproducing the building's interior 3115, according to the location, path and interior of the required medical department, planting “incidental” mirrors for the player's self facial image, etc. The virtual reality interior may be reproduced from photographs of the hospital, while its spaces may be populated by animated characters (patients, doctors, nurses, etc.).

Personal customization to the player, such as facial and body images, clothing, etc. as well as personal customization of the gaming application is done at 3116. Finally, the fully customized VR gamified application 3117 is ready for playing.

The gamified application is played in two steps of integrated reality: physical reality and digital reality. The physical reality consists of a playful construction of the hospital model out of plastic bricks 3118. Thereafter, the child experiences a virtual visit in the hospital using either VR glasses, tablet screen or mobile device's screen 3119.

### Exemplary Case #2. 3D Shooter Games With High Degree of Visual Realism and Self Identification

A first-person shooter (FPS) is a subgenre of 3D shooter games in which the gameplay consists primarily of shooting. It is a video game centered on gun fighting and other weapon-based combat seen from a first-person perspective. Third-person shooter (TPS) is closely related to first-person shooters, but with the player character visible on-screen during play. The TPS genre is distinguished by having the game presented with the player's avatar as a primary focus of the camera's view.

An uppermost immersive experience for the shooting gamer may be only achieved by high degree of visual realism and self identification with the shooting person, both may be delivered only by a real-time ray tracing technology. Ray tracing is superior to raster graphics by its capability to simulate a wide variety of optical effects, such as glossiness, specularity, radiosity, reflection and refraction, scattering, soft shadows and more. The generated images are not only faithful to reality, but they are also capable to deliver a maximal experience of bodily self-consciousness. The use of mirror in the game may give us feedback on who we are and what we are experiencing at the moment. A quick glance in a mirror reaffirms our sense of self. If our facial image replaces the face of a movie character, then on top of his visual reflection one can identify with the hero.

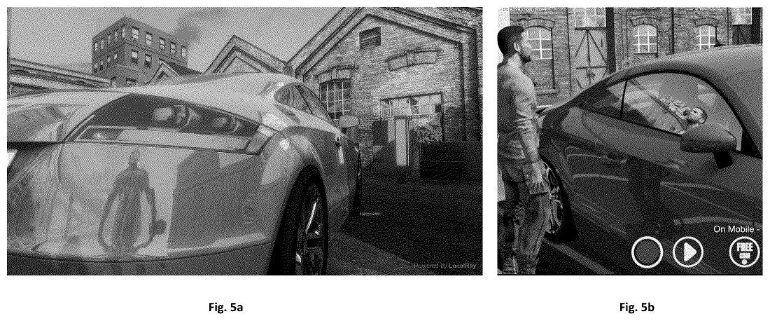

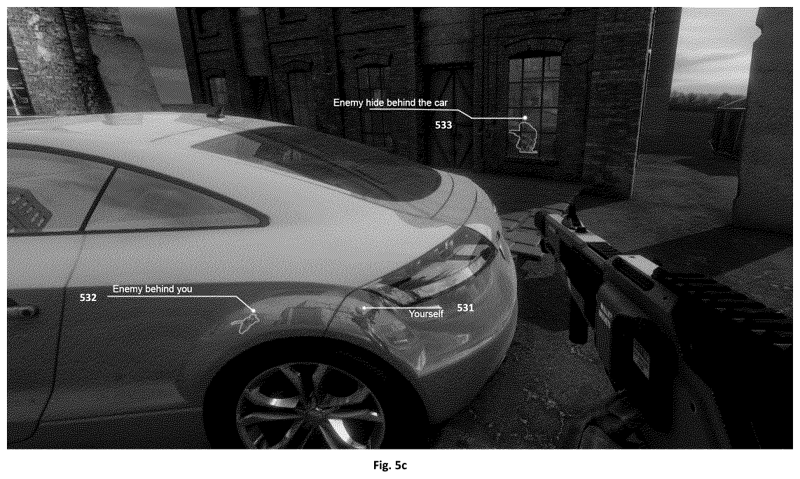

FIG. 5a shows a reflection in a car created by a real-time ray tracing of a first-person shooter player. A third-person shooter view of the player's avatar and his reflection in a car is shown in FIG. 5b. Reflections are physically accurate, allowing the player to trust them and rely on them as extra layer of information that helps immerse into the game. A story maybe found inside the reflection with off screen objects or animations, allowing explore new and exciting camera angles. This is illustrated in the scene of FIG. 5c, where a close FPS view is shown. The reflections at the car provide new information to the player. He can see himself mirrored at 531, helping him to experience bodily self-consciousness and raise his involvement. There is an enemy behind the player, reflected at 532. Yet another enemy is hiding behind the car, reflected at a window of a standby building 533. Reflections hint what is happening behind you or in hidden parts of the scene to catch danger before time.

This is a new level of gaming taking the gamer's experience a quantum leap upward, changing the gaming rules. Certainly, a new level design and game strategy is required for such a scene. The game designers need to raise the design level according to the new and unique information provided to the gamer, wherein the gamer needs to make a tactical and strategic decision in a blink of time.

The development cycle of 3D shooter games with high degree of visual realism and self identification, following FIG. 3. It is divided to development phase 3120 and customization phase 3121.

In physical reality part 3111 of the development phase a physical toy construction (PTC) of a neighborhood of industrial buildings and hangars is designed (the virtual reality counterpart is shown in FIGS. 5a and 5b), built out of plastic bricks. Such physical reality construction consists of toy building exteriors and their outdoor environment (cars, trees, streets, lawn, etc.).

In the digital part of the first phase a generic, site specific VR gamified application is developed. Firstly, a VR environment modeled after PTC is developed as a gaming world 3112, mainly the industrial buildings and their outdoor (FIGS. 5a and 5b). Special attention is given to the presence of reflective objects on the site, such windows, shiny cars, beverage machines with reflective panels, etc. Then the gaming is designed 3113, including storyline, pre-customized characters (e.g. enemies), user interface, etc. A mutual induction between steps 3112 and 3113 allows placing mirroring objects in critical junctions of the gaming plot. A site specific but still generic VR gamified application has been created 3114. Its generic state leaves room for adaptation to designated players.

The second phase 3121 comprises customization. In this exemplary case the step 3115 consists mainly of mirroring windows, shining cars, etc. In next step 3116 a personal customization of the game characters, such as facial and body images, clothing, arms, etc. is done. If required, a personal customization of the gaming storyline may be done. Finally, the fully customized VR gamified application 3117 is ready for playing a customized 3D shooter game.

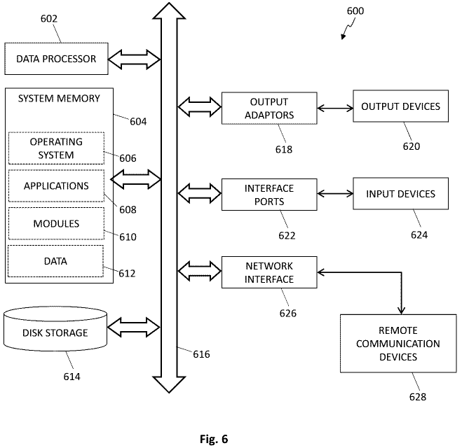

FIG. 6 illustrates an exemplary system 600 for implementing various aspects of the invention. System 600 includes a data processor 602, a system memory 604, and a system bus 616. The system bus 616 couples the system components including, but not limited to, the system memory 604 to the data processor 602. The data processor 602 can include one or more of any of the various available processors. The data processor 602 refers to any integrated circuit or other electronic devices (or collection of devices) capable of operating on at least one instruction, including, without limitation, Reduced Instruction Set Core (RISC) processors, CISC microprocessors, Microcontroller Units (MCUs), CISC-based Central Processing Units (CPUs), Digital Signal Processors (DSPs), Graphics processing unit (GPU), and General-purpose graphics processing unit (GPGPU). Furthermore, various functional aspects of the data processor 602 may be implemented solely as software or firmware associated with the processor. Dual microprocessors and other multiprocessor architectures also can be employed as the data processor 602.

The system bus 616 can be any of several types of bus structure(s) including the memory bus or memory controller, a peripheral bus or external bus, and/or a local bus using any variety of available bus architectures known to those of ordinary skill in the art.

The system memory 604 may include computer-readable storage media comprising volatile memory and nonvolatile memory. The non-volatile memory stores the basic input/output system (BIOS), containing the basic routines to transfer information between elements within the system 600. Nonvolatile memory can include but is not limited to, read-only memory (ROM), programmable ROM (PROM), electrically programmable ROM (EPROM), electrically erasable programmable ROM (EEPROM), or flash memory. The volatile memory includes random access memory (RAM), which acts as external cache memory. RAM is available in many forms such as static RAM (SRAM), dynamic RAM (DRAM), synchronous DRAM (SDRAM), double data rate SDRAM (DDR SDRAM), enhanced SDRAM (SDRAM), SynchLink™ DRAM (SLDRAM), Rambus® direct RAM (RDRAM), direct Rambus® dynamic RAM (DRDRAM), and Rambus® dynamic RAM (RDRAM).

The system memory 604 includes an operating system 606 which performs the functionality of managing the system 600 resources, establishing user interfaces, and executing and providing services for applications software. System applications 608, modules 610, and data 612 provide various functionalities to system 600.

System 600 also includes disk storage 614. Disk storage 614 includes, but is not limited to, devices like a magnetic disk drive, floppy disk drive, tape drive, Jaz drive, Zip drive, LS-100 drive, flash memory card, or memory stick. In addition, disk storage 614 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM).

A user enters commands or information into system 600 through input device(s) 624. Input devices 624 include, but are not limited to, a pointing device (such as a mouse, trackball, stylus, or the like), a keyboard, a microphone, a joystick, a satellite dish, a scanner, a TV tuner card, a digital camera, a digital video camera, a web camera, and/or the like. The input device 624 connects to the data processor 602 through the system bus 616 via interface port(s) 622. Interface port(s) 622 include, for example, a serial port, a parallel port, a game port, and a universal serial bus (USB).

The output devices 620 like monitors, speakers, and printers are used to provide the output of the data processor 602 to the user. Another example is a USB port that may be used as an input device 624 to provide input to system 600 and output information from system 600 to output device 620. The output device 620 connects to the data processor 602 through the system bus 616 via output adaptor 618. The output adapters 632 may include, for example, video and sound cards that provide a means of connection between the output device 620 and the system bus 616.

System 600 can communicate with remote communication devices 628 for exchanging information. The remote communication device 628 can be a personal computer, a server, a router, a network PC, a workstation, a microprocessor-based appliance, a mobile phone, a peer device, or another common network node and the like.

Network interface 626 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring, and the like. WAN technologies include, but are not limited to, point-to-point links, circuit switching networks like Integrated Services Digital Networks (ISDN) and variations thereon, packet switching networks, and Digital Subscriber Lines (DSL).

1. A method for creating an integrated reality gamified application that integrates a physical reality and a virtual reality, and is capable of supporting bodily self-consciousness and enabling camera angles with off-screen objects, to be played by one or more players, the method comprising:
providing a physical construction of interlocking plastic bricks, to be used as a prototype for a virtual reality gamified application; and
developing a process of the virtual reality gamified application implemented by a real- time ray tracing, wherein the development process comprises:
designing and developing a virtual reality environment modelled after the physical prototype, having a real, non-interlocking components look;
designing and developing a gaming storyline taking place in the virtual reality environment;
feeding personal data of a designated player;
customizing the gaming storyline to the designated player; and
customizing the virtual reality environment to the designated player and to the customized gaming storyline;
wherein:
the development process is configured to creating a customized gaming application supporting real-time reflections for bodily self-consciousness of the designated player and for camera angles with off-screen objects.

2. The method of claim 1, wherein the real-time ray tracing enables insertion and usage of mirroring surfaces in the virtual reality gamified application.

3. The method of claim 1, wherein customizing the gaming storyline to the designated player includes mirroring the designated player's facial images to support his bodily self-consciousness.

4. The method of claim 1, wherein customizing the virtual reality environment includes placing reflecting surfaces in critical junctions of the gaming storyline.

5. The method of claim 1, wherein the support of real-time reflections enables viewing camera angles with off-screen objects and animation.

6. The method of claim 1, wherein the personal data of the designated player includes at least his facial images.

7. The method of claim 1, wherein the personal data of the designated player may include special personal needs, if applicable.

8. A method of an integrated reality gamified application that integrates a physical reality and a virtual reality, to be played by one or more players, the method comprising:
pre-game;
player becomes a designated player upon feeding his personal data;
in the physical reality;
player builds a physical model constructed of interlocking plastic bricks, serving as a prototype for a virtual reality environment;
in the virtual reality;
the designated player plays within the virtual reality environment, the environment is a digital reconstruction of previously completed physical construction, having an enhanced, real and non-interlocking look; and
the designated player plays a gamified application customized according to his personal data.

9. The method of claim 8, wherein the personal data includes player's facial images, enabling him to experience mirroring of his facial images to support bodily self-consciousness, over the course of the virtual reality environment.

10. The method of claim 8, wherein the designated player with special needs, may play a game adapted to his needs, given that the needs are included in the personal data.

11. The method of claim 1, wherein the real-time ray tracing-based virtual reality enables to take advantage of camera angles with off-screen objects and animation.

12. A system for developing an integrated reality gamified application that integrates a physical reality and a virtual reality, and is capable of generating real-time reflections, to be played by one or more players, the system comprising:
providing a physical construction of interlocking plastic bricks, to be used as a prototype for a virtual reality gamified application; and
applying a real-time ray tracing technology for developing a process of a virtual reality gamified application, wherein the development process comprises:
designing and developing a virtual reality environment modelled after the physical prototype, having a real, non-interlocking components look;
designing and developing a gaming storyline taking place in the virtual reality environment;
feeding personal data of a designated player;
customizing the gaming storyline to the designated player; and
customizing the virtual reality environment to the designated player and to customized storyline.

13. The system of claim 12, wherein the real-time ray tracing enables insertion and usage of mirroring surfaces in the gamified application.

14. The system of claim 13, wherein the real-time mirroring surfaces enable generating player's bodily self-consciousness.

15. The system of claim 13, wherein the real-time mirroring surfaces enable camera angles with off-screen objects and animation.
